(19) United States
(12) Patent Application Publication
(10) Pub. No.: US 2016/0176518 A1
(43) Pub. Date: Jun. 23, 2016

(54) BRAKE ACTUATOR FOR AIRCRAFT WHEEL HYDRAULIC BRAKE

(71) Applicant: MESSIER-BUGATTI-DOWTY, Velizy-Villacoublay (FR)

(72) Inventors: Victor EYANGA, Royaume-Uni (GB); Vincent GONZALEZ, Velizy-Villacoublay (FR)

(73) Assignee: MESSIER-BUGATTI-DOWTY, Velizy-Villacoublay (FR)

(21) Appl. No.: 14/967,435

(22) Filed: Dec. 14, 2015

(30) Foreign Application Priority Data
Dec. 17, 2014 (FR) 14 62611

(51) Int. Cl. B64C 25/44; F16D 65/74; F16D 55/41; F16D 65/18

(52) U.S. Cl. CPC B64C 25/44; F16D 65/18; F16D 65/74; F16D 55/41; F16D 2121/04

(57) ABSTRACT

The invention relates to a brake actuator for an aircraft hydraulic brake, which is intended to be added into one of the cavities of a brake ring, the actuator comprising:
a liner (1) designed to be housed sealingly in the cavity of the ring;
a piston (3) mounted to slide sealingly in the liner along an axis of sliding so as to apply a braking force when a fluid is introduced under pressure into the cavity;
a wear compensation device (10) which defines a position to which the piston retreats into the liner by means of a mobile stop (11; 111) that can be moved forward by the piston as a braking force is applied;
an elastic return member (18) returning the piston towards the retracted position bearing against the mobile stop;
   according to the invention, the mobile stop is associated with a notched indexing member (13) allowing the mobile stop to move under the thrust of the piston, but preventing any return motion of the mobile stop with respect to the liner.

The invention relates to a brake actuator for an aircraft wheel hydraulic brake.

### TECHNICAL BACKGROUND OF THE INVENTION

The hydraulic brakes used for braking the wheels of aircraft generally comprise a ring having multiple cavities in which brake actuators are housed removably. Each of the actuators comprises a liner which is sealingly added to one of the cavities of the ring and in which a piston is mounted to slide sealingly along an axis of sliding. The ring distributes hydraulic fluid under pressure to all its cavities, which fluid acts on the piston in order to cause it to deploy and apply a braking force to friction elements extending opposite the ring, including rotors which rotate with the wheels and stators which are prevented from rotating.

In general, the piston has an operational travel that it covers when a braking force is applied. This operational travel, of the order of a few millimetres, is enough to allow the braking force to be applied to the friction elements and to cause the push-rod to retreat to allow the rotors to rotate freely. To this end, a spring extending inside the piston ensures that the push-rod retreats into a retracted position when the braking force is no longer applied.

However, the friction elements gradually become worn as a result of repeated application of braking forces so it is important to ensure that the piston is always near the friction elements. In order to achieve this it is known practice to fit the brake actuators with a wear compensation device that extends inside the piston. The wear compensation device comprises a mobile stop which is mounted to slide with friction along the axis of sliding on a central rod extending into the piston and which defines the position to which the piston retreats.

When a braking force is applied, the piston is pushed towards the friction elements and, if necessary, carries the mobile stop along with it, overcoming the friction between the rod and the stop, thereby causing the mobile stop to move forward along the central rod. When the force is released, the spring, which extends between the mobile stop and the piston, causes the piston to retreat as far as the new retracted position, which has moved forward because the mobile stop has moved forward. To that end, the mobile stop is associated with a friction member which immobilises the mobile stop but which nonetheless allows it to advance under the thrust of the piston when the latter has not reached the friction elements of the brake.

In certain circumstances, it has been observed that, in those regions of the liner against which bears the friction member associated with the mobile stop, the piston seal could wear more rapidly, which reduces the leaktightness of the actuator.

### OBJECT OF THE INVENTION

It is an object of the invention to propose a brake actuator for an aircraft hydraulic brake that avoids the above-mentioned drawbacks.

### PRESENTATION OF THE INVENTION

In order to achieve this goal, there is proposed a brake actuator for an aircraft hydraulic brake, which is intended to be added into one of the cavities of a brake ring, the actuator comprising:
a liner designed to be housed sealingly in the cavity of the ring;
a piston mounted to slide sealingly in the liner along an axis of sliding so as to apply a braking force when a fluid is introduced under pressure into the cavity;
a wear compensation device which defines a position to which the piston retreats into the liner by means of a mobile stop that can be moved forward by the piston as a braking force is applied;
an elastic return member returning the piston towards the retracted position bearing against the mobile stop;
   in which, according to the invention, the mobile stop is associated with a notched indexing member allowing the mobile stop to move under the thrust of the piston, but preventing any return motion of the mobile stop with respect to the liner.

This does away with the problems linked to wear of the friction materials in an environment which may be polluted by carbon dust or by hydraulic fluid. The notched indexing member defines a succession of stable positions of the mobile stop, preventing the latter from moving backwards even in the event of pollution. The seal of the piston no longer passes over a portion of the wall of the liner which would have been stressed or even damaged by a friction member, which is rendered useless due to the presence of the notched indexing member.

According to one preferred embodiment, the notched indexing member comprises:
a notched wall associated with one of the liner and the mobile stop;
a deformable ring having on one hand notched portion suitable for engaging with the notched wall, and on the other hand a conical seat suitable for engaging with a conical seat associated with the other of the liner and the mobile stop;
return means returning the deformable ring against the seat so as to immobilise the stop by means of engagement between the ring and the notched wall;
the mobile stop being able to advance by one or more notches relative to the deformable ring when the piston comes to bear against the mobile stop and causes the ring to lift off from the notched wall counter to the return means.

### BRIEF DESCRIPTION OF THE DRAWINGS

The invention will be better understood in the light of the following description given with reference to the figures of the attached drawings, among which:

FIG. 1 is a view in section of a brake actuator according to the invention, illustrated in place in a ring of an aircraft hydraulic brake at rest;

FIG. 2 is a figure similar to FIG. 1, the actuator being illustrated as a standard braking force is being applied, the operational travel of the piston being not entirely exhausted;

FIG. 3 is a figure similar to FIG. 2, the actuator being illustrated as a braking force is being applied, the operational travel of the piston being entirely exhausted before the piston comes into contact with the discs;

FIG. 4 is a figure similar to FIG. 3, showing the forward movement of the mobile stop in order that the piston can come into contact with the discs;

FIG. 5 is a figure similar to FIG. 4, the actuator being illustrated after the braking force has been released.

FIGS. 6 and 7 are figures similar to FIG. 1 of variant embodiments of the actuator of the invention.

### DETAILED DESCRIPTION OF THE INVENTION

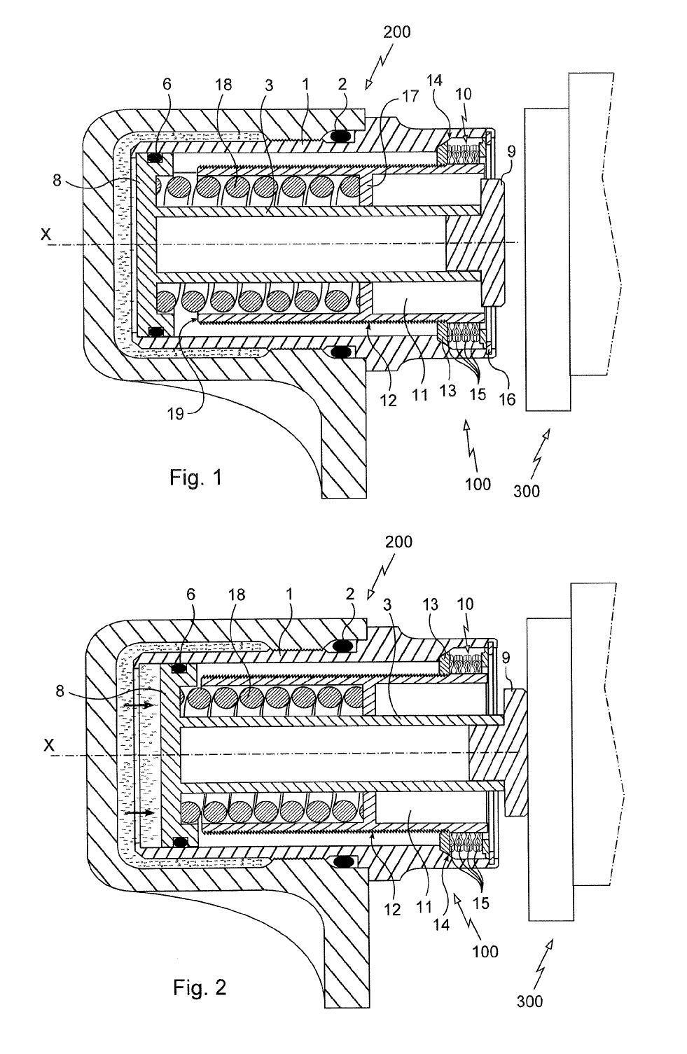

With reference to FIG. 1, the brake actuator 100 of the invention is intended to be housed in one of the cavities 200 of a ring of an aircraft hydraulic brake, which moreover comprises friction elements 300 comprising a succession of rotor discs and stator discs, for example discs made of carbon, on which the actuator selectively applies a braking force when pressurized fluid (illustrated as dots) is admitted to the cavity 200.

The actuator 100 first of all comprises a generally cylindrical liner 1 which is housed sealingly inside the cavity 200 of the ring. For that purpose, a seal 2 collaborates with an external face of the liner to contain the hydraulic fluid within the cavity.

A piston 3 is mounted to slide in the liner 1 along an axis of sliding X. To that end, the piston 3 comprises a proximal end 8 that is shaped like a bearing which fits closely against an internal face of the liner 1 and which receives a seal 6.

It will be noted that the proximal end 8 of the piston 3 is in this instance closed by a wall formed as an integral part of the piston, so as to confine the hydraulic fluid in a zone distant from the discs 300. The distal end of the piston 3 accommodates a shoe 9 to apply pressure to the discs 300.

The actuator 100 is provided with a wear compensation device 10 which, according to the invention, extends between the liner 1 and the piston 3. The wear compensation device 10 comprises a mobile stop 11 in the general shape of a bushing whose external wall comprises notches 12. This notched external wall 12 engages with a deformable split ring 13 whose internal diameter is also notched and which comprises a conical seat which engages with a conical seat 14 of the liner 1 so as to close the ring 13 onto the notched wall 12. To that end, a set of elastic washers 15 extends between the split ring 13 and an arresting ring 16 acting as a stop. The purpose of these elastic washers 15 is to permanently push the split ring 13 back against the conical seat 14 in order to force it to close on the notches of the notched external wall 12, and thus immobilise the mobile stop 11. The mobile stop 11 comprises an internal protrusion 17 which defines a stop for a return spring 18 extending between said protrusion 17 and the piston 3 in order to return the latter to the retracted position.

One of the end faces 19 of the mobile stop 11 (oriented towards the proximal end 8 of the piston 3) may be engaged by the piston 3 itself when the operational travel has been entirely exhausted before the piston 3 reaches the discs 300, as will be explained below.

The way in which the brake actuator of the invention works is as follows. Starting from the retracted position illustrated in FIG. 1, a braking force is applied by admitting pressurized fluid to the cavity 200. The fluid pushes the piston 3 towards the discs 300, counter to the force of the spring 18. The piston 3 then applies a pressing force on the discs 300, as illustrated in FIG. 2.

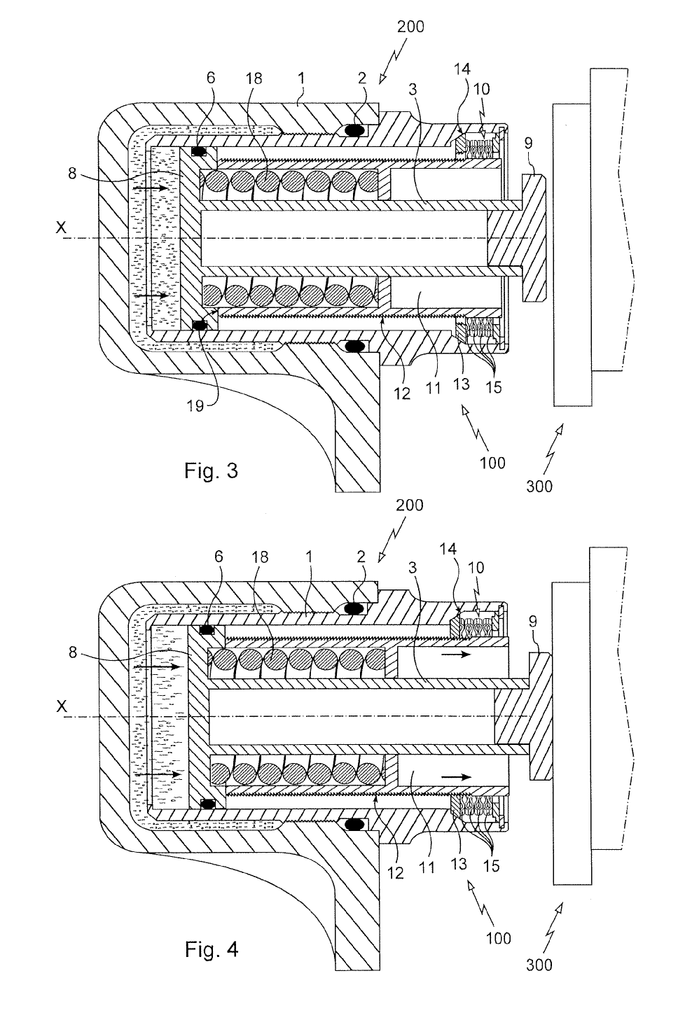

However, it may be that the distance between the shoe 9 and the discs is greater than the operational travel of the piston 3. In this situation, and as illustrated in FIG. 3, before coming into contact with the discs 300, the piston 3 causes the spring 18 to compress to the point that the piston 3 meets the end face 19 of the mobile stop 11. The piston 3 then pushes the mobile stop 11 against the resistive force of the elastic washers 15, the effect of which is to cause the split ring 13 to rise up on its conical seat 14.

If the thrust of the piston 3 continues, the resistive force of the elastic washers 15 will become large enough to force the split ring 13 to open, such that the latter jumps one or more notches to allow the mobile stop 11 to move forward under the thrust of the piston 3, while returning to abut against its conical seat 14, as shown in FIG. 4. The split ring 13 returning against the base of the conical seat 14 has the effect of confirming the former around the mobile stop 11, thereby immobilising the latter in a new position which is further forward than the preceding position. The notches prevent any backward movement of the mobile stop 11.

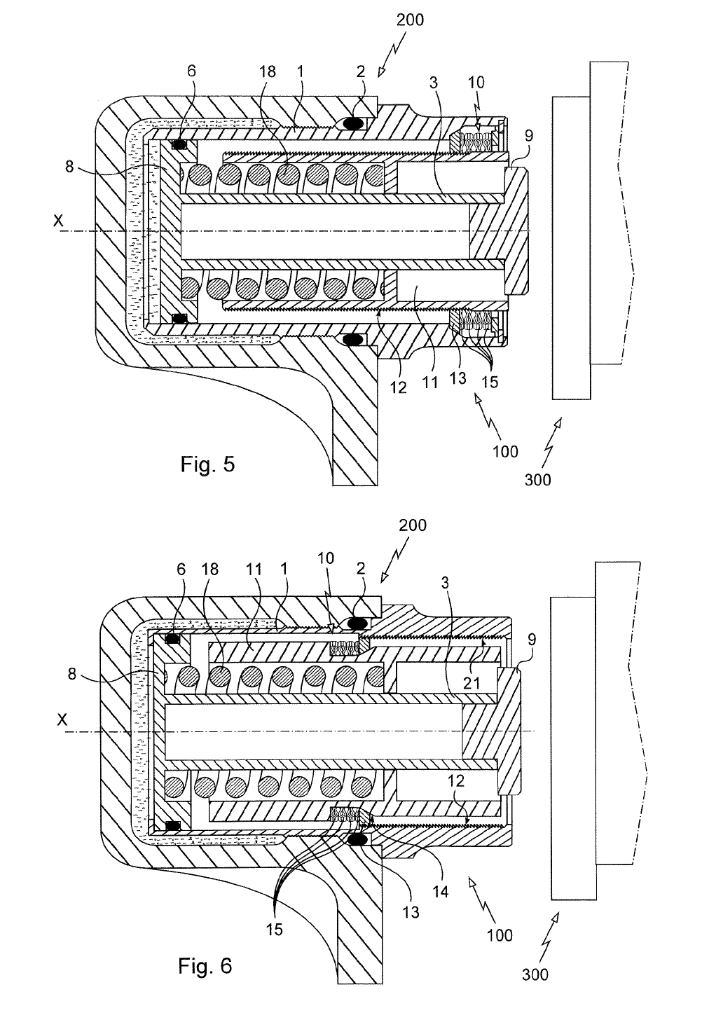

Then, when the braking force is released, the piston 3 moves back under the effect of the spring 18, thus defining a new retracted position which is further forward than the preceding position. The operational travel of the piston (between the position of FIG. 4 and the position of FIG. 5) is unchanged, only the retracted position having moved forward slightly in order to compensate for the wearing of the discs 300.

In the embodiment variant shown in FIG. 6, the notches are now borne by an internal surface 21 of the liner 1 which extends in the continuation of the cylindrical surface against which the seal 6 rubs. It is to be noted that the inclination of the notches is the reverse of that in FIGS. 1 to 4. The split ring 13 is also reversed, and it is its external diameter which is now notched. The conical seat 14 is now formed in the mobile stop 11, the elastic washers 15 still forcing the split ring 13 to press against the conical seat 14. The operation of this variant is in every way similar to that which has been described above.

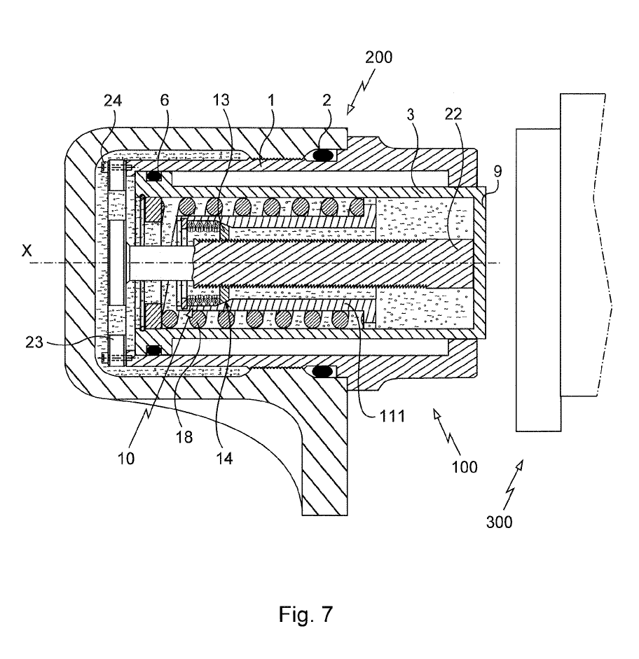

In the embodiment variant shown in FIG. 7, the notches are now borne by a central rod 22. Here, the mobile stop 111 is still in the form of a bushing but extends between the central rod 22 and the piston 3, such that the spring 18 extends inside the piston 3 and not around it as before. The conical seat 14 is now formed inside the mobile stop 111. The central rod 22 comprises a head 23 secured to the liner 1 by means of screws 24, such that the notched wall is connected to the liner 1. It will be noted in this case that the hydraulic fluid is not held back by a wall of the proximal end of the piston 3 and that therefore the entire interior of the piston 3, including the wear compensation mechanism 10, is bathed therewith, the operation of the latter being in no way affected thereby. Indeed, the notches and the closure of the split ring 13 on the notches due to its pressure on the conical seat 14 immobilise the mobile stop 111 even when the wear compensating mechanism 10 is bathed in the hydraulic fluid.

The invention is not restricted to that which has just been described but on the contrary encompasses any variant that falls within the scope defined by the claims.

1. Brake actuator for an aircraft hydraulic brake, which is intended to be added into one of the cavities of a brake ring, the actuator comprising:
a liner (1) designed to be housed sealingly in the cavity of the ring;
a piston (3) mounted to slide sealingly in the liner along an axis of sliding so as to apply a braking force when a fluid is introduced under pressure into the cavity;
a wear compensation device (10) which defines a position to which the piston retreats into the liner by means of a mobile stop (11; 111) that can be moved forward by the piston as a braking force is applied;
an elastic return member (18) returning the piston towards the retracted position bearing against the mobile stop;
in which, according to the invention, the mobile stop is associated with a notched indexing member (13) allowing the mobile stop to move under the thrust of the piston, but preventing any return motion of the mobile stop with respect to the liner.

2. Brake actuator according to claim 1, in which the notched indexing member comprises:
a notched wall associated with one of the liner (1) and the mobile stop (11; 111);
a deformable ring (13) having on one hand a notched portion suitable for engaging with the notched wall, and on the other hand a conical seat suitable for engaging with a conical seat associated with the other of the liner and the mobile stop;
return means (15) returning the deformable ring against the seat so as to immobilise the stop by means of engagement between the ring and the notched wall;
the mobile stop being able to advance by one or more notches relative to the deformable ring when the piston comes to bear against the mobile stop and lifts the ring off from the notched wall counter to the return means.

3. Brake actuator according to claim 2, in which the mobile stop (11) extends around the piston and comprises an outer wall oriented towards the liner, which is notched.

4. Actuator according to claim 2, in which the mobile stop (11) extends around the piston, the liner having an inner wall oriented towards the mobile stop, which is notched.

5. Actuator according to claim 2, in which the mobile stop (111) extends inside the piston, the liner being associated with a central rod (22) having an outer wall oriented towards the mobile stop, which is notched.
